(19) United States
(12) Patent Application Publication
(10) Pub. No.: US 2021/0265770 A1
(43) Pub. Date: Aug. 26, 2021

(54) METHOD OF SEALING A PLUG CONNECTOR

(71) Applicant: HIRSCHMANN AUTOMOTIVE GMBH, Österreich (AT)

(72) Inventors: Guenter JAEGER, Goetzis (AT); Lukas TOMASINI, Lustenau (AT)

(21) Appl. No.: 17/260,657

(22) PCT Filed: Jul. 31, 2019
(86) PCT No.: PCT/EP2019/070602

§ 371 Date: Jan. 15, 2021

(30) Foreign Application Priority Data
Jul. 31, 2018 (DE) 10 2018 118 481.6

(51) Int. Cl. H01R 13/52; H01R 43/00

(52) U.S. Cl. CPC H01R 13/5208; H01R 43/005

(57) ABSTRACT

The invention relates to a plug connector, comprising an injection-molded contact carrier (1) made of plastic and having contact chambers for receiving one contact partner each. Furthermore, a sealing element (2) acting upon, in each case, an outer jacket of at least one cable (5) that is led out of the plug connector, and the end of the electrical conductor thereof is connected to the associated contact partner is provided. The sealing element (2) is formed by plastic processed in an injection molding process, together with the contact carrier (1), wherein the sealing element (2) is injection-molded directly onto the contact carrier (1) at at least one predetermined breaking point, preferably exactly two predetermined breaking points (10).

The invention relates to a plug connector and to a method of making the plug connector that has a contact support that is injection molded from plastic and has contact chambers for receiving respective contact partners, wherein furthermore provided is a sealing element that acts on an outer jacket of at least one cable that extends out of the plug connector and the end of whose electrical conductor is connected to the respective contact partner, wherein the sealing element is formed together with the contact support from plastic processed in an injection molding process.

A plug connector of the generic type is known from DE 10 2011 055 215 A1. This plug connector has a plastic support that is injection molded from plastic and has contact chambers for receiving respective contact partners, wherein furthermore provided is a sealing element that acts on an outer jacket of at least one cable that extends out of the plug connector and the end of whose electrical conductor is connected to the respective contact partner, wherein the sealing element is formed together with the contact support from plastic processed in an injection molding process. A method of making a plug connector is likewise disclosed, this plug connector having a contact support that is injection molded from plastic and has contact chambers for receiving respective contact partners, wherein furthermore provided is a sealing element that acts on an outer jacket of at least one cable that extends out of the plug connector and the end of whose electrical conductor is connected to the respective contact partner, wherein the sealing element is likewise produced from plastic in an injection molding process and joined to the contact support after this sealing element has been produced. In this respect, the joining connection to the sealing element is designed such that the movable part of the sealing element protrudes laterally, which can lead to damage during the packaging, transport and processing.

The invention is based on the object of improving a plug connector of the generic type and also a method of the generic type in terms of the production of the plug connector such that the disadvantages described are avoided.

The object of the invention is achieved by the features of the two independent patent claims 1 and 9.

After the contact support is loaded with a corresponding number of contact partners that have been inserted into their respective contact chamber in the contact support, the at least one predetermined break point can easily be severed so that the sealing element that previously did not bear against the outer jacket of the cable, comes to bear closely against the outer jacket of the cable, in order thus to prevent injection molding compound for producing a housing around the contact partner from penetrating into the inner region of the contact chambers of the contact support. The contact support is thus loaded with contact partners that are arranged at the end of the cable, more precisely at the end of the electrical conductor of the cable, and then the at least one predetermined break point, preferably exactly the two predetermined break points, is severed, so that the sealing element, together with an respective geometry on the contact partner, seals the respective contact chamber to the effect that the situation in which, when a housing of the plug connector is injection molded, injection molding compound penetrates into a respective contact chamber is avoided. This can be effected by a force-fitting and/or form-fitting connection, for example a latching connection. The arrangement of the sealing element over the at least one predetermined break point on the contact support has the advantage that this sealing element is available for the subsequent injection molding process and cannot be lost or forgotten.

In a development of the invention, it is provided that the sealing element has a fixed part arranged on the contact support and a latching part that is articulated via the at least one predetermined break point. In this respect, it is preferable when two predetermined break points are provided on both sides between the fixed part and the latching part. The predetermined break points are aligned in the longitudinal direction with respect to the plug connector, with the result that the latching part can be displaced by a transverse movement with respect to the plug connector for the purpose of sealing at least one cable. The latching part or the fixed part has lateral tabs that correspond to grooves on the fixed part or latching part, so that the parts are guided with respect to one another as a result. Provided in the region of the tabs and grooves are latching elements that create a form-fitting connection of the latching part to the fixed part.

In addition, provided on the fixed part and the latching part, preferably on the outer surfaces thereof, are projections that can be latched into openings on a sealing cap. The projections can, however, also serve as guide elements for a sealing cap encapsulated by injection molding. The sealing cap that can be arranged over the end of the contact support, receives a form-fitting fastening as a result. Encircling sealing lips can be provided on the projections in order to improve the sealing of the sealing cap on the projections.

A single embodiment of the invention is illustrated in a simplified manner in the drawings, in which:

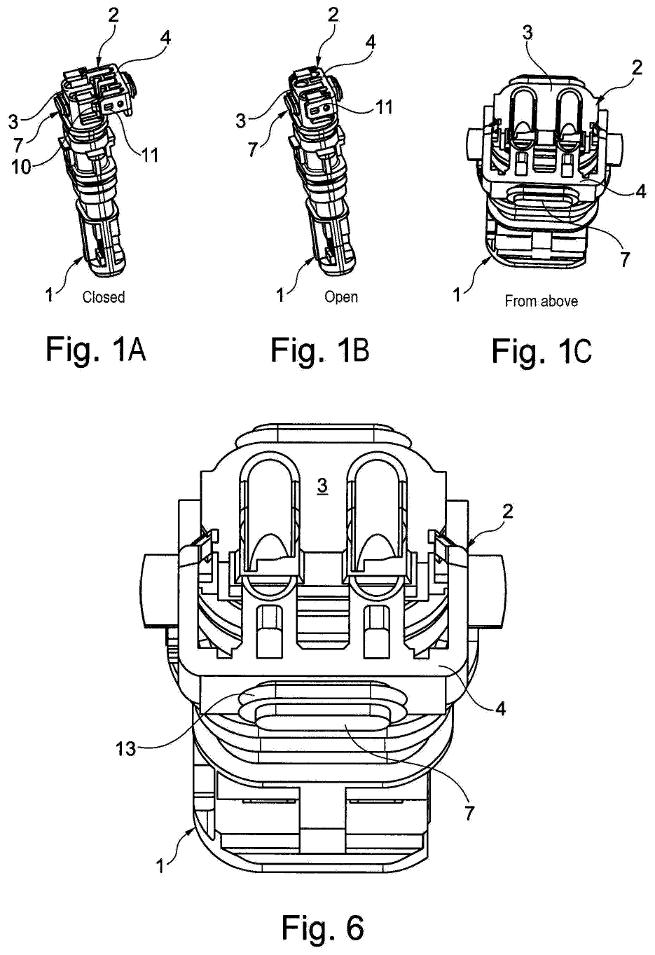

FIG. 1 [A-C] shows three views of a contact support, a latching part being fixed via predetermined break points in the left-hand view [FIG. 1A], the latching part being connected to a fixed part of the sealing element in the central view [FIG. 1B], and the contact support being shown in enlarged scale, corresponding to the central view from the top, in the right-hand view [FIG. 1C],

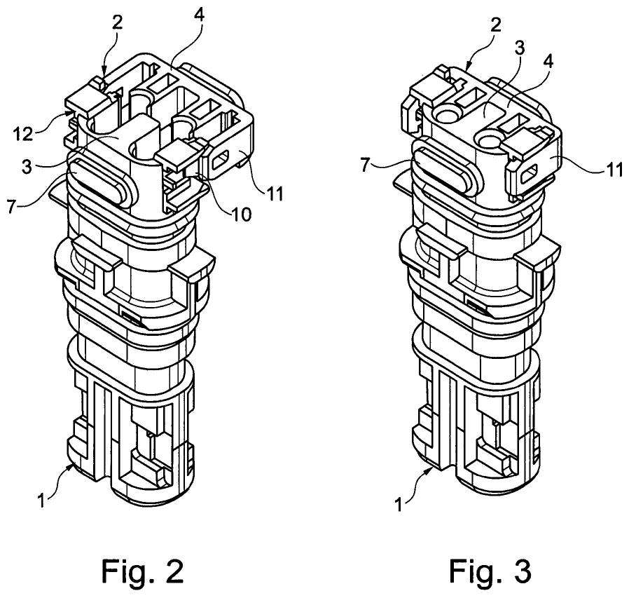

FIGS. 2 and 3: show the left-hand view [FIG. 1B] and the central view [FIG. 1B] of FIG. 1 in enlarged scale,

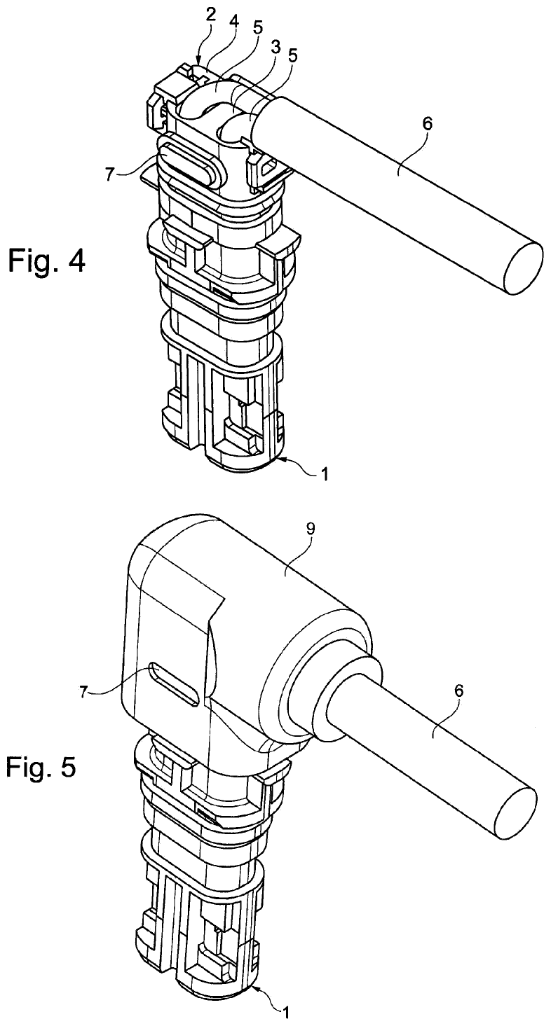

FIG. 4 shows a contact support with two connected cables and a protective sleeve,

FIG. 5 shows a wired contact support with protective sleeve and additional sealing cap, and

FIG. 6 shows a view of the contact support from above as per the right-hand view [FIG. 1A] of FIG. 1 in enlarged scale.

Referenced by the reference numeral 1 in FIGS. 1 to 6, to the extent to which it is shown specifically, is a contact support having a sealing element 2. The sealing element 2 contains, inter alia, a fixed part 3 fixed to the sealing element and a latching part 4 that is fixed by predetermined break points 10 to the fixed part 3 and/or to the sealing element 2. Grooves 12 are incorporated on the fixed part 3 of the sealing element 2 following the predetermined break points 10. The latching part 4 has tabs 11 that are assigned to the grooves 12. If the latching part 4 is displaced in the direction of the fixed part 3 as per FIG. 2 in the view as per FIG. 3, firstly the predetermined break points 10 are detached and the latching part 4, while being guided by the tabs 11 and the grooves 12, is moved in the direction of the fixed part 3 and is connected in a form-fitting manner to this fixed part.

If, as illustrated in FIG. 4, cables 5 are inserted beforehand into the contact support 1 and/or the sealing element 2, the outer jacket of the cable 5 is clamped in between the fixed part 3 and the latching part 4 and sealed.

An additional sealing of the region of the plug connector 1, sealing element 2 and cable(s) 5 is brought about by a sealing cap 9 that can be injection molded on or latched in by openings 8 on projections 7. Sealing lips 13 on the projections 7 improve the sealing. The projections 7 are arranged in the region of the sealing element 2 on the outer walls of the fixed part 3 and of the latching part 4.

### LIST OF REFERENCE SIGNS

1 Contact support
2 Sealing element
3 Fixed part
4 Latching part
5 Cable
6 Protective sleeve
7 Projections
8 Openings
9 Sealing cap
10 Predetermined break points
11 Tabs
12 Grooves
13 Sealing lips

1. A plug connector comprising:
a contact support that is injection molded from plastic and has contact chambers for receiving respective contact partners, and
a sealing element that acts on an outer jacket of a cable that extends out of the plug connector and the end of whose electrical conductor is connected to the respective contact partner, the sealing element being formed together with the contact support from plastic processed in an injection molding process, wherein the sealing element is injection molded directly on the contact support at a predetermined break point.

2. The plug connector according to claim 1, wherein the sealing element has a fixed part arranged on the contact support and a latching part that is articulated via the predetermined break point.

3. The plug connector according to claim 1, wherein two predetermined break points are provided on both sides between the fixed part the latching part.

4. The plug connector according to claim 3, wherein the predetermined break points are aligned in the longitudinal direction with respect to the contact support and in that the latching part can be displaced by a transverse movement with respect to the contact support for the purpose of sealing the cable.

5. The plug connector according to claim 1, wherein the latching part has lateral tabs that are assigned to grooves on the fixed part.

6. The plug connector according to claim 1, wherein latching hooks and/or latching eyes are arranged on the tabs and in the region of the grooves.

7. The plug connector according to claim 1, further comprising:
projections provided on the fixed part and the latching part and that serve as guide elements for a sealing cap encapsulated by injection molding or as latching bodies for openings on the sealing cap.

8. The plug connector according to claim 1, wherein the projections have encircling sealing lips.

9. A method of making a plug connector having:
a contact support that is injection molded from plastic and has contact chambers for receiving respective contact partners and a break point,
a sealing element that acts on an outer jacket of a cable that extends out of the plug connector and the end of whose electrical conductor is connected to the respective contact partner, the method comprising the steps of:
making the sealing element from plastic in an injection molding process, joined
thereafter joining the sealing element to the contact support after this sealing element has been produced,
injection molding the sealing element directly on the contact support at the break point; and thereafter
severing the break point so that the sealing element comes to bear against the outer jacket of the cable.
